(19) United States
(12) Patent Application Publication
(10) Pub. No.: US 2018/0260687 A1
(43) Pub. Date: Sep. 13, 2018

(54) Information Processing System and Method for Operating Same

(71) Applicant: Hitachi, Ltd., Chiyoda-ku, Tokyo (JP)

(72) Inventors: Yusuke KANNO, Tokyo (JP); Takeshi SAKATA, Tokyo (JP); Shigeru NAKAHARA, Tokyo (JP)

(21) Appl. No.: 15/761,217

(22) PCT Filed: Apr. 26, 2016
(86) PCT No.: PCT/JP2016/063072

§ 371 Date: Mar. 19, 2018

(51) Int. Cl. G06N 3/04; G06N 3/08

(52) U.S. Cl. CPC G06N 3/0454; G06N 3/08

(57) ABSTRACT

Efficient learning of a neural network can be performed. A plurality of DNNs are hierarchically configured, and data of a hidden layer of a DNN of a first hierarchy machine learning/recognizing device is used as input data of a DNN of a second hierarchy machine learning/recognizing device.

### TECHNICAL FIELD

The present invention relates to a general machine learning field such as a social infrastructure system field, and more particularly to, a hierarchy type deep neural network system.

### BACKGROUND ART

In a CPU installed in a server or the like, it has become difficult to improve performance of an operation processability relying on size reduction, and the limits of a von Neumann computer as a computer architecture have come to the surface. With such a background, researches on non-von Neumann computing have been actively conducted. Deep learning has emerged as a candidate of the non-von Neumann computing.

The deep learning is known as a machine learning technique of a neural network of a multi-layer structure (a deep neural network (DNN)). It is a technique based on a neural network, but it has been recently reviewed again due to an improvement in a recognition rate by a convolutional neural network in an image recognition field. The deep learning can be applied to a wide variety of devices from image recognition terminals for automatic driving to cloud computing for big data analysis.

On the other hand, in recent years, a possibility of Internet of things (IoT), in which all devices are connected to a network has been suggested, and efforts to provide small-size terminal devices with a high-performance process and efficiently use the social infrastructure have also been actively made. As described above, the improvement in the operation speed of the processor installed in the server or the like has reached the limit, but with the development of semiconductor microfabrication technology, there is room for an increase in a degree of integration of LSIs, particularly, in embedded systems, and various devices have been actively developed. Particularly, the considerable development of general purpose graphic processing units (GPGPUs) and field programmable gate arrays (FPGAs) is also a contributor.

### CITATION LIST

### Patent Document

Patent Document 1: JP 8-292934 A

Patent Document 2: JP 5-197705 A

### SUMMARY OF THE INVENTION

### Problems to be Solved by the Invention

Patent Document 1 discloses a technique in which, in order to accurately obtain a derivative of a network in a short time in addition to an output value of the network, a configuration using a first network and a second network is provided, the first network calculates a sigmoid function, the second network calculates a derivative function of the sigmoid function, and thus a computational efficiency is improved by performing real four arithmetic operations.

On the other hand, a technique disclosed in Patent Document 2 relates to a learning system of a neural network having a wide variety of application fields such as recognition of patterns or characters and various kinds of control, and it is an object of the technique to provide, for example, a neural network learning system which is capable of efficiently performing learning at a high speed while suppressing an increase in a hardware amount using a plurality of neural networks which differs in the number of units of an intermediate layer.

However, the techniques disclosed in Patent Documents mentioned above are not effective solutions for implementing deep learning in which the neural network is set deeper in the IoT environment. It is because the above-mentioned systems are based on the concept that each output is used for the purpose, and thus there is no concept of reconfiguring a network in each hierarchy and efficiently utilizing computational resources. However, in the IoT field which is expected to be put to practical use in the future, systems capable of performing efficient operations and changing a configuration appropriately depending on the situation even in a situation in which there are limitations to a hardware size, power, and an operation performance of hardware installed in a terminal side as described in the background art are required.

In addition, in IoT, a decisive difference from an environment in which embedded devices of the related art are used is intervention of a network, and it is possible to utilize large-scale operation resources existing in a different place to a certain extent via the network. Therefore, it is expected that adding of value of embedded devices in the IoT era will expand rapidly in the future, and technology of realizing this is required.

In this situation, efforts to seeking future technology directionality have been made. In computers, only parts having a small size and limited operation performance can be used in a terminal part, but parts having large computational resources (computing capability and a room information integrated storage device) can be used in a central part, but in the IoT era, efficient operation processing is required in the terminal part. To this end, neural network-based technology is promising, and it is necessary to construct the neural network while effectively using operation resources which can be currently used. This is considered to be an innovative information processing device. Further, since control according to a property of tracking a control target at a high speed such as a real time property or a control latency is necessary as control for the terminal, such requirements are unable to be satisfied in control using only commands from a central computer. A framework in which efficient processing can be performed in conjunction with the central computer is also important. Further, there is also a point of view that a huge system is constructed by trillion sensors in the IoT era, and since it is difficult to control all the sensors in a centralized manner, a system in which each terminal can be autonomously controlled is also required.

In brief, the problems are as follows.

(1) It is necessary to develop innovative information control devices under various kinds of limitations (the hardware size, the power, and the operation performance) in the embedded devices.

(2) Since it is possible to use operation resources which are physically separated via the network in the IoT era, it is necessary to develop technology of using the resources effectively.

(3) It is necessary to develop a system in which autonomous control can be performed since a huge system is expected to be constituted by trillion sensors in the IoT era.

### Solutions to Problems

One aspect of the present invention to solve the above problem provides an information processing system including a plurality of DNNs which are hierarchically configured, in which data of a hidden layer of a DNN of a first hierarchy machine learning/recognizing device is used as input data of a DNN of a second hierarchy machine learning/recognizing device.

In a more specific example, after supervised learning is performed in the DNN of the first hierarchy machine learning/recognizing device so that an output layer performs a desired output, supervised learning of the DNN of the second hierarchy machine learning/recognizing device is performed.

In another specific example, a hardware size of the second hierarchy machine learning/recognizing device is larger than a hardware size of the first hierarchy machine learning/recognizing device.

Another aspect of the present invention provides a method for operating an information processing system including a plurality of DNNs including configuring the plurality of DNNs to have a multi-layer structure including a first hierarchy machine learning/recognizing device and a second hierarchy machine learning/recognizing device, in which information processing capability of the second hierarchy machine learning/recognizing device higher than information processing capability of the first hierarchy machine learning/recognizing device is used, and data of a hidden layer of a DNN of the first hierarchy machine learning/recognizing device is used as input data of a DNN of the second hierarchy machine learning/recognizing device.

In a more specific preferred example, a configuration of a neural network of the first hierarchy machine learning/recognizing device DNN is controlled on the basis of a processing result of the second hierarchy machine learning/recognizing device.

In another aspect of the present invention, a unit that performs an operation on data of a second layer using data of a first layer and performs an operation on data of the first layer using data of the second layer in a multi-layered neural network is provided. Weight data of deciding a relation between each piece of data of the first layer and each piece of data of the second layer in both the operations is provided, and the weight data is stored in one storage holding unit as all weight coefficient matrices to be constructed. Further, an operation unit including product-sum operators which are constituent elements of the weight coefficient matrix and correspond to operations of matrix elements in a one-to-one manner is provided, and when the matrix elements constituting the weight coefficient matrix are stored in the storage holding unit, the matrix elements are stored using a row vector of the matrix as a basic unit, and the operation of the weight coefficient matrix is performed in basic units in which the storage is performed in the storage holding unit.

Here, a first row component of the row vector is held in the storage holding unit so that an arrangement order of constituent elements is the same as a column vector of an original matrix. Further, a second row component of the row vector is held in the storage holding unit after shifting the constituent element of the column vector of the original matrix to the right or the left by one element. Further, a third row component of the row vector is held in the storage holding unit after further shifting the constituent element of the column vector of the original matrix by one element in the same direction as a movement direction in the second row component. Further, an N-th row component of the last row of the row vector is held in the storage holding unit further shifting the constituent element of the column vector of the original matrix by one element in the same direction as a movement direction in an (N−1)-th row component.

Further, an operator configuration in which, in a case in which the data of the first layer is calculated from the data of the second layer using the weight coefficient matrix, the data of the second layer is arranged similarly to the column vector of the matrix, and each element is input to the product-sum operator, at the same time, a first row of the weight coefficient matrix is input to the product-sum operator, a multiplication operation related to both pieces of data is performed, and an operation result is stored in the accumulator, when second or less rows of the weight coefficient matrix are calculated, the data of the second layer is shifted to the left or the right each time a row operation of the weight matrix is performed, and then a multiplication operation of element data of a corresponding row of the weight coefficient matrix and the arranged data of the second layer is performed, then, data stored in the accumulator of the same operation unit is added, and a similar operation is performed up to an N-th row of the weight coefficient matrix is provided.

Further, in a case in which the data of the second layer is calculated from the data of the first layer using the weight coefficient matrix, the data of the first layer is arranged similarly to the column vector of the matrix, and each element is input to the product-sum operator, at the same time, a first row of the weight coefficient matrix is input to the product-sum operator, a multiplication operation is performed, and a result is stored in the accumulator, when second or less rows of the weight coefficient matrix are calculated, the data of the first layer is shifted to the left or the right each time a row operation of the weight matrix is performed, and then a multiplication operation of element data of a corresponding row of the weight coefficient matrix and the arranged data of the first layer is performed, then, information of the accumulator stored in the operation unit is input to an adding unit of a neighbor operation unit, added to the result of the multiplication operation, and a result is stored in the accumulator, and a similar operation is performed up to the N-th row of the weight matrix.

Another aspect of the present invention provides a system in which an inter-neuron connection is calculated using a weight coefficient decided by learning in advance, and interim data is generated in a neural network device having three or more network layers which is installed in a first hierarchy. The interim data is interim data obtained by extracting a feature point in classifying input data. The generated interim data is input to a neural network device in an upper-level hierarchy which is installed in a second hierarchy. The neural network device of the second hierarchy receives output signals from intermediate layers of one or more neural network devices in the first hierarchy. Then, the neural network device of the second hierarchy receives inputs from one or more first hierarchy neural network devices and performs new learning.

### Effects of the Invention

There is an effect in that it is possible to perform efficient learning as a whole since a more amount of information is input to the DNN of the server.

### BRIEF DESCRIPTION OF THE DRAWINGS

FIGS. 1A and 1B are system conceptual diagrams for describing a basic concept of an embodiment of the present invention.

FIGS. 1C and 1D are configuration blocks according to a first embodiment of the present invention.

FIG. 2A is a diagram illustrating a configuration of a first hierarchy, and FIG. 2B is an explanatory diagram of a configuration between operation nodes in the first embodiment of the present invention.

FIG. 3A is a block diagram illustrating another form of an example illustrated in FIG. 2A.

FIG. 3B is a diagram illustrating a communication protocol of a first hierarchy and a second hierarchy.

FIG. 4 is a flow chart illustrating a sequence of updating DNN information of a first hierarchy.

FIG. 5 is an explanatory block diagram when an FPGA is applied to a first hierarchy DNN device of the present invention.

FIG. 6 is a block diagram according to a second embodiment of the present invention.

FIG. 7 is a block diagram according to a third embodiment of the present invention.

FIG. 8 is a block diagram according to a fourth embodiment of the present invention.

FIG. 9 is a block diagram according to a fifth embodiment of the present invention.

FIG. 10 is a block diagram according to a sixth embodiment of the present invention;

FIG. 11 is a block diagram according to a seventh embodiment of the present invention.

FIG. 12 is a block diagram according to an eighth embodiment of the present invention.

FIG. 13 is a block diagram according to a ninth embodiment of the present invention.

FIG. 14 is a block diagram according to a tenth embodiment of the present invention.

FIG. 15 is a block diagram according to an eleventh embodiment of the present invention;

FIG. 16 is a block diagram according to a twelfth embodiment of the present invention.

FIG. 17 is a block diagram according to a thirteenth embodiment of the present invention.

FIGS. 18A to 18C are block diagrams according to a fourteenth embodiment of the present invention.

### MODE FOR CARRYING OUT THE INVENTION

Hereinafter, exemplary embodiments of the present invention will be described with reference to the appended drawings. However, the present invention is not interpreted to be limited to the description of the embodiments set forth below. It would be easily understood by those skilled in the art that a specific configuration of the present invention can be modified within the scope not departing from the spirit of the present invention.

In a configuration of the invention to be described below, parts having the same or similar functions are denoted by the same reference numerals in different drawings, and redundant descriptions may be omitted.

In a case in which there are a plurality of constituent elements that are considered to be equivalent in embodiments, they are distinguished by attaching suffixes to the same symbols or numbers. However, in a case in which it is unnecessary to distinguish them particularly, the suffixes may be omitted.

In this specification, notations such as “first,” “second,” and “third” are attached to identify constituent elements and need not necessarily limit numbers or an order. Further, numbers identifying constituent elements are used for each context, and the numbers used in one context does not necessarily indicate the same configuration in other contexts. A constituent element identified by a certain number is not precluded from doubling as a function of a constituent element identified by another number.

A position, a size, a shape, a range, or the like of each component illustrated in the drawings or the like may not indicate an actual position, an actual size, an actual shape, an actual range, or the like in order to facilitate understanding of the invention. Therefore, the present invention is not necessarily limited to a position, a size, a shape, a range, or the like illustrated on the drawings or the like.

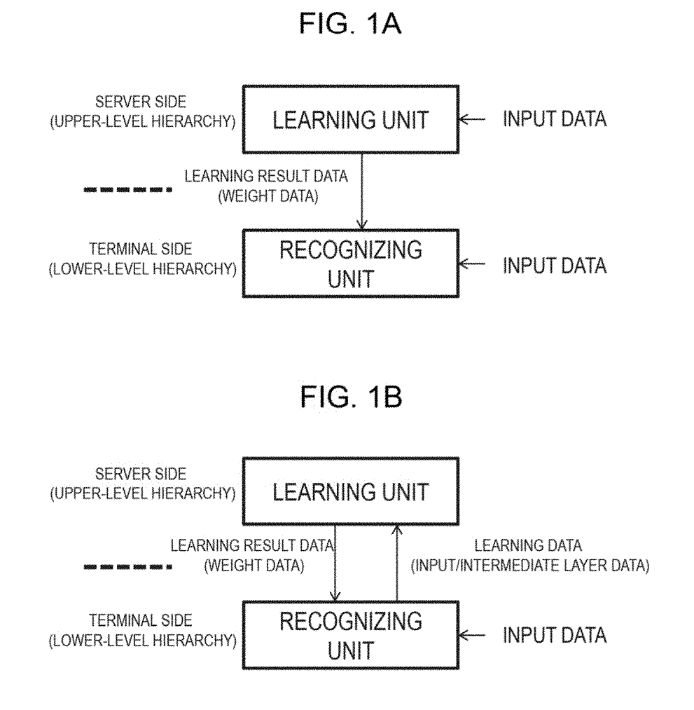

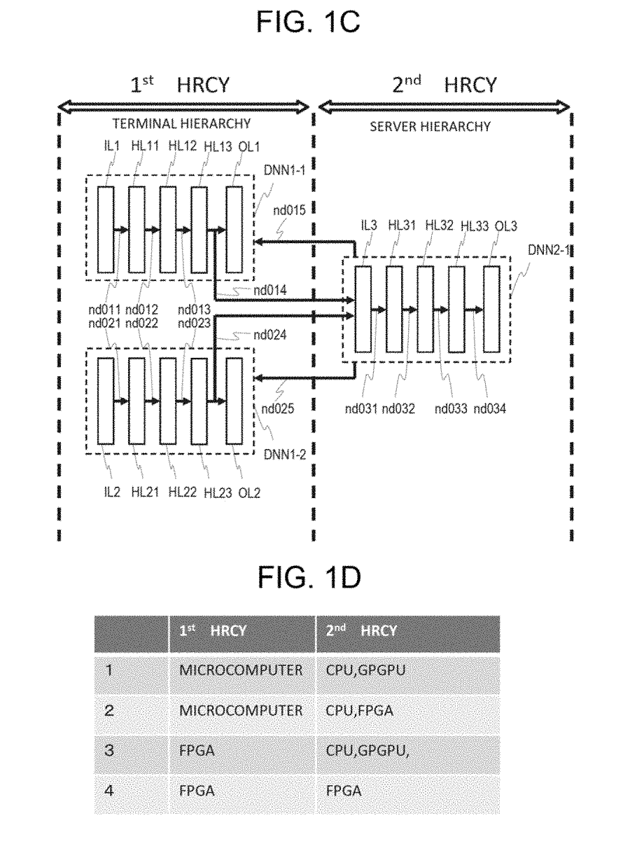

FIGS. 1A and 1B illustrate a basic concept of the present embodiment. In a case in which a hierarchical DNN is constituted between a plurality of terminals and a server, a simplest example is a system in which learning is performed on a server side as illustrated in FIG. 1A, and a learning result is transmitted to a terminal side, and recognition is performed on the terminal side. However, when the inventors of the present application have reviewed the DNN, the inventors of the present application have found that, when interim data of a DNN operation is used in a recognizing unit, the learning on the upper-level server side becomes more efficient.

In other words, as illustrated in FIG. 1B, input data of the terminal side or intermediate layer data of the DNN when recognition is performed on the terminal side is transmitted to the server side while using data of the terminal side, learning is performed on the server side, a learning result in the server is transmitted to the terminal side at an appropriate timing, and a recognition operation is performed in the terminal. Data output from the intermediate layer of the DNN of the terminal is used as the input of the DNN of the server side, and learning is performed in the DNN in each hierarchy. As a learning method, supervised learning of the DNN of the terminal is performed, and then supervised learning of the DNN of the server is performed.

The DNN device on the terminal side is constituted by a device which is small in size and area and low in power consumption, and the DNN device on the server side is constituted by a so-called server that performs a high-speed operation and includes a large capacity memory.

### First Embodiment

FIGS. 1C and 1D are diagrams illustrating a main embodiment of the present invention. FIG. 1C illustrates a system constituted by a plurality of machine learning devices DNN1-1 to DNN2-1. In the machine learning device, paths indicated by nd011 to nd014, nd021 to nd024, and nd031 to nd034 indicate paths connecting hierarchies of respective neural networks.

In the present embodiment, a machine learning/recognizing device of a first hierarchy (1^{st} HRCY) and a machine learning/recognizing device of a second hierarchy (2^{nd} HRCY) are hierarchically connected to each other as a system configuration. Each machine learning/recognizing device DNN includes an input layer IL, an intermediate layer HL, and an output layer OL. Further, in a deep neural network work that constitutes the first hierarchy machine learning/recognizing device as a connection between the first hierarchy machine learning/recognizing device and the second hierarchy machine learning/recognizing device, data (nd014 and nd024) of the intermediate layer HL called a hidden layer which is generated during a recognition process other than data of the output layer OL at the time of recognition is input to the second hierarchy machine learning/recognizing device.

Generally, the data from the output layer OL is output as data for presenting a recognition result as a histogram or the like for each previously classified category and constituted by data indicating how the input data is classified as a result of recognition. The data from the intermediate layer (hidden layer) HL is data obtained by extracting a feature quantity of the input data. In the present embodiment, the reason for using the intermediate layer data is that the intermediate layer data is data obtained by extracting a feature of input data and can be used as high-quality data in the learning in the second hierarchy machine learning/recognizing device.

Signals (nd015 and nd025) from the second hierarchy learning/recognizing device to the first hierarchy learning/recognizing device are signals indicating a network or a weight of the first hierarchy learning/recognizing device or signals for giving an instruction to change them. A change signal is issued when it is necessary to change the recognition or the network of the first hierarchy learning/recognizing device in the learning or recognition process in each of the first and second hierarchies. Accordingly, it is possible to improve the recognition rate of the first hierarchy learning/recognizing device in an actual operation situation.

Various systems have been proposed as the deep neural network (DNN), and a convolutional neural network (CNN) has been actively studied in recent years. In this CNN-type network, for a part corresponding to the hidden layer, a part of an original image is clipped (which is called kernel), so-called image convolution is performed by a product-sum operation of a pixel unit with a weight filter having the same size as it, and then a pooling operation of performing coarse graining on the image is further performed, and thus a plurality of pieces of small data are generated. In the hidden layer, information serving as a feature of an original image is efficiently extracted.

The inventors have studied data conversion in the machine learning and have found that efficiency of learning can be improved, for example, by using data obtained by extracting the feature shown in the hidden layer of the CNN.

For example, image recognition learning is considered. Generally, in the case of image data, humans can understand the meaning included in the image data, but it is often hard for machines to find the meaning. The data of the hidden layer is processed so that the feature of the image emphasized and showed while simultaneously compressing information by a convolution operation with weight data or coarse graining according to a statistical process with surrounding pixels. In the CNN, it is possible to emphasize the feature quantity by performing the feature extraction process, and image determination becomes close to a correct solution by processing the feature quantity. In the case of a recognizing device which has performed learning sufficiently, the data of the intermediate layer can be regarded to be valued data in which the feature is emphasized.

In efficient learning in which it is important to use a large amount of data in learning, the following points are generally important:

(1) input data sufficient to perform learning should be provided; and

(2) In the case of a neural network-type learning machine, an operation proportional to the number of neurons is necessary, and computational resources (operation performance, a hardware scale, and the like) should be sufficient.

On the other hand, since a situation on the terminal side changes with every moment when IoT is applied, a requirement such as

(3) flexible adaptation (a low latency and a high-speed feedback)

is also necessary when a cooperation with an embedded system is considered. However, when a large number of terminals are considered as IoT,

(4) it is necessary to deal with a so-called complex system.

The first hierarchy 1^{st} HRCY and the second hierarchy 2^{nd} HRCY are installed as described in the present embodiment, and thus, for example, in the first hierarchy on the terminal side, it is configured with a machine learning/recognizing device having a low latency, a small size, and a limited function and capable of giving a high-speed feedback so that the requirement of (3) described above is satisfied. In the second hierarchy, a high-performance CPU or the like is installed, and it is possible to utilize computational resources capable of using a large-capacity memory system, and thus the requirement of (2) described above is also satisfied.

FIG. 1D illustrates a configuration example of a combination of four types of hardware used in the first hierarchy and the second hierarchy. In this example, a hardware size on the second hierarchy side is larger than a hardware size on the first hierarchy side. Generally, as the hardware size is large, an information processing capability increases.

Since the learning of the second hierarchy machine learning/recognizing device is performed using data of the hidden layers of a plurality of first hierarchy machine learning/recognizing devices, the optimization can be implemented through the machine learning using information from each of the first hierarchy machine learning/recognizing devices, and thus the requirement of (4) described above is also satisfied. Further, since data obtained by efficiently extracting the features of a plurality of first hierarchy machine learning devices can be used as the input, the learning in the second hierarchy can be improved in terms of a quality for the requirement of (1) described above as compared with similar learning to recognition in the first hierarchy using the input data in the related art. It is because the value from the hidden layer is used instead of the output layer of the machine learning/recognizing device, and thus a more amount of information is input to the second hierarchy machine learning/recognizing device.

Each of the first hierarchy machine learning/recognizing device and the second hierarchy machine learning/recognizing device can be provided with a learning function. As an example, the supervised learning is performed by the first hierarchy machine learning/recognizing device, and then the supervised learning of the second hierarchy machine learning/recognizing device is performed. In this case, it is easier to perform the easier as compared with a case in which the entire system is a single DNN. Further, since the learning of the second hierarchy machine learning/recognizing device can be performed using data from other first hierarchy machine learning/recognizing devices as the input data, it is possible to increase the data amount efficiently, and it is possible to improve the learning efficiency and the learning outcome.

Further, the second hierarchy machine learning/recognizing device performs the supervised learning by using the hidden layer value calculated by the first hierarchy machine learning/recognizing device as the input, and thus when the learning in the second hierarchy machine learning/recognizing device is repeated, the first hierarchy machine learning/recognizing device need not perform an operation again. An effect in that it is possible to reduce an operation amount at the time of learning is also obtained.

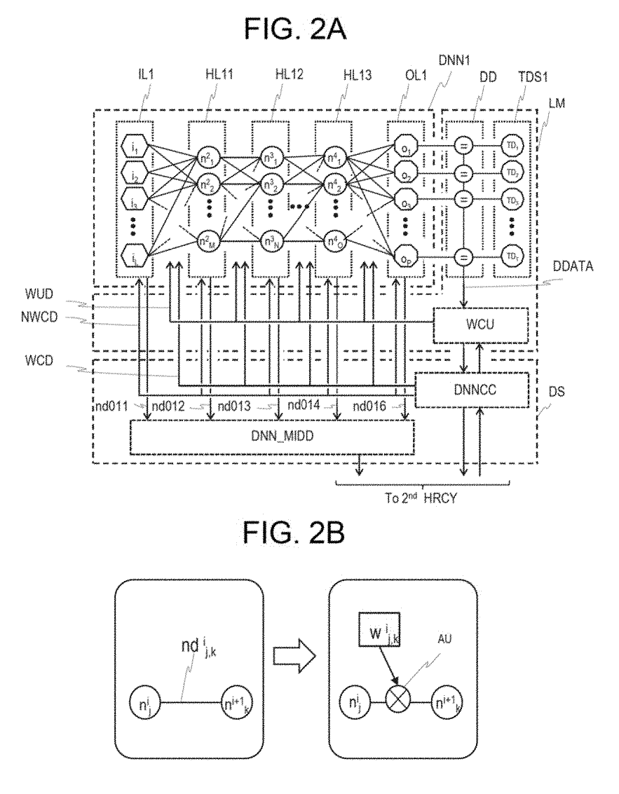

FIGS. 2A and 2B illustrate a specific configuration of the first hierarchy machine learning/recognizing device (DNN1). As illustrated in FIG. 2A, the neural network type machine learning/recognizing device includes nodes (i₁ i_{L}) to of an input layer IL1, nodes (o₁ to O_{P}) of an output layer OL1, and nodes (n²₁ to n²_{M}, n³₁ to n³_{N}, and n⁴₁ to n⁴_{O}) of hidden layers HL11 to HL13, and an arithmetic operation (AU) of an weight wⁱ_{j,k} and input node nⁱⱼ is input to a connection between the nodes, for example, a connection between nⁱⱼ and nⁱ⁺¹ₖ as illustrated in FIG. 2B.

A DNN network configuration control unit (DNNCC) is a control circuit that controls a network configuration of the DNN. DNN configuration data is stored as information of a neural network configuration information data transmission line (NWCD) and a weight coefficient change line (WCD), and the information is reflected in the DNN device if necessary. The configuration data can be associated with a so-called configuration memory when an FPGA to be described below is used.

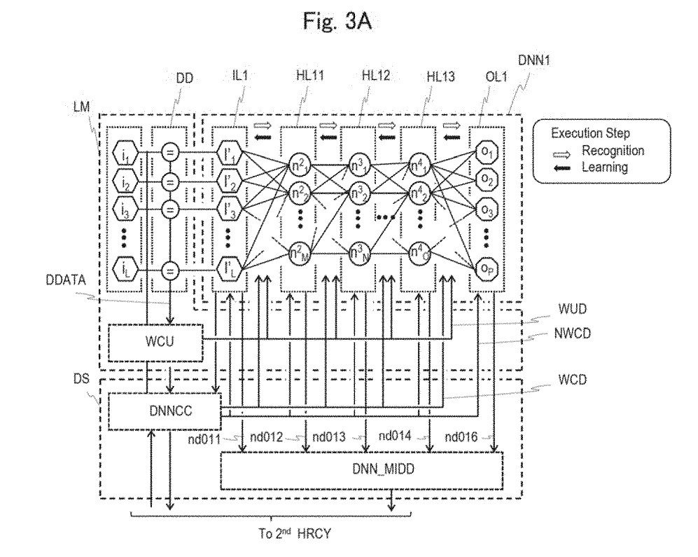

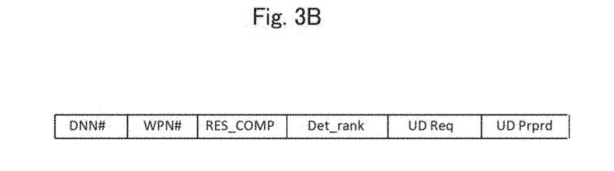

The DNN network configuration control unit (DNNCC) can communicate with the second hierarchy machine learning/recognizing device (DNN2). Contents of the DNN configuration data can be transmitted to the second hierarchy machine learning/recognizing device, and content of the DNN configuration data can be received from the second hierarchy machine learning/recognizing device. Data for communication will be described later with reference to FIG. 3B.

A data accumulation memory (DNN_MIDD) has a function of holding data of each layer of the neural network and outputting the data to the second hierarchy machine learning/recognizing device. In the example of FIGS. 1C and 1D, the form in which data of nd014 and nd024 is transmitted to the second hierarchy machine learning/recognizing device has been described, but in the example of FIG. 2A, data nd011 to nd016 of each layer is stored in the data accumulation memory (DNN_MIDD), and thus the data nd011 to nd016 of an arbitrary layer among the input layer, the intermediate layer, and the output layer can be transmitted to the second hierarchy machine learning/recognizing device, and a flexible system design can be made.

Although not explicitly illustrated in FIGS. 1C and 1D, a learning module (LM) is necessary when the learning is performed. This is generally a known technique called supervised learning, but it is important to evaluate how much an output result of a result of performing an operation in the DNN1 deviates from so-called training data (TDS1) which is considered a correct solution, and it is learning to change a weight coefficient of the neural network on the basis of a deviation amount. In FIGS. 2A and 2B, an error detecting unit (deviation detection (DD)) calculates an error amount (DDATA) by comparing the operation result of the DNN1 with the training data (TDS1) and generates and stores comparison result information with correct resolution information or recognition result rating information if necessary. A weight coefficient adjusting circuit (WCU) decides a weight on the basis of the result, stores the weight, the weight coefficient is set by a weight coefficient change lines (WUD), and a weight defined in each of neural networks nⁱⱼ and nⁱ⁺¹ₖ is changed.

FIG. 3A illustrates another configuration example of the first hierarchy machine learning/recognizing device (DNN1). There is also a reverse propagation technique in which, depending on a target of machine learning, a reverse operation (learning) of the recognition operation is performed using data of the last stage output layer OL1 which has undergone the recognition process (recognition) as the input, it returns to the input layer IL1, and an operation is performed by the error detecting unit (DD) as illustrated in FIG. 3A. In this case, since the training data can be realized by the input data (i1 to iL), there is an effect in that it is possible to implement recognition performance according to an appropriate situation by input data serving as a target with data generated by the reverse propagation without preparing training data newly.

A setting in which the learning module (LM) is not installed is possible. This is because the first hierarchy machine learning/recognizing device is supposed to operate with very limited operation resources, and thus it may be desirable to make a hardware configuration specialized for the recognition process. In this case, it is possible to simply evaluate the error through the comparison with the training data, and it is effective to hold score information of a recognition result for the recognition obtained as a result, for example, in a part of the data accumulation memory (DNN_MIDD). This is because it is also possible to transmit data related to data processing in which the score information is bad (the neural network configuration information, the weight coefficient information, the input data, the interim data, the score information, and the like) to the second hierarchy machine learning/recognizing device at an appropriate timing and reconfigure the first hierarchy machine learning/recognizing device through the efficient learning in the second hierarchy.

As a configuration example, the first hierarchy machine learning/recognizing device (DNN1) includes a unit that stores a score of a recognition result of the recognition process while performing the recognition process and an update request transmitting unit that transmits an update request signal for a neural network structure and a weight coefficient of the DNN of the first hierarchy machine learning/recognizing device to the second hierarchy machine learning/recognizing device when the recognition result is larger than a predetermined threshold value 1 or smaller than a predetermined threshold value 2 or when a variance when a histogram of the recognition result is generated is larger than a predetermined value.

Upon receiving the update request signal of the first hierarchy machine learning/recognizing device, the second hierarchy machine learning/recognizing device (DNN2) updates the neural network structure and the weight coefficient of the DNN of the first hierarchy machine learning/recognizing device, and transmits the update data to the first hierarchy machine learning/recognizing device. In the first hierarchy machine learning/recognizing device (DNN1), a new neural network is constructed on the basis of update data.

FIGS. 2A and 3A illustrate specific the examples of the first hierarchy machine learning/recognizing device (DNN1). A basic structure of the second hierarchy machine learning/recognizing device (DNN2) is also similar. Here, the supervised learning is performed using the data from the hidden layer HL of the first hierarchy machine learning/recognizing device (DNN1) as the input of the second hierarchy machine learning/recognizing device (DNN2). Further, an interface that performs data communication with the DNN network configuration control unit (DNNCC) and the data accumulation memory (DNN_MIDD) of the first hierarchy machine learning/recognizing device (DNN1) is provided.

FIG. 3B is a diagram illustrating a communication protocol of the first hierarchy and the second hierarchy. A structure of data held in the first hierarchy in both situations of a case in which learning is performed by the first hierarchy machine learning/recognizing device and a case in which learning is not performed is illustrated.

In FIG. 3B, information indicating the feature of the first hierarchy machine learning/recognizing device includes neural network configuration information (DNN #), weight coefficient information (WPN #), comparison result information (RES_COMP) with correct solution information, recognition result information (such as a recognition correct solution rate: Det_rank), and a configuration update request signal (update request) (UD Req) of the first hierarchy machine learning/recognizing device.

Particularly, the configuration update request signal of the first hierarchy machine learning/recognizing device is a configuration of at most several bits, and the second hierarchy machine learning/recognizing device periodically checks the configuration update request signal of the first hierarchy machine learning/recognizing device and detects whether or not an update is necessary. In a case in which the information indicates an update necessity request, preparation for transferring the latest data that has been added and learned in the second hierarchy machine learning/recognizing device is performed, and if it is possible to prepare for the transfer of the data update information, request update preparation completion signal data is transmitted to the first hierarchy machine learning/recognizing device and stored in data of the first hierarchy machine learning/recognizing device. The data is stored as UD_Prprd.

Various cases are considered for the updating of the configuration information. After the recognition process of a certain period elapses in the first hierarchy machine learning/recognizing device, for example, an average recognition rate (for example, recognition result rating information) is calculated, and when a threshold value is exceeded, communication with the second hierarchy machine learning/recognizing device is established. Then, integrated data necessary for the update is transmitted from the first hierarchy to the second hierarchy, and the learning is efficiently performed by the second hierarchy machine learning/recognizing device. Thereafter, after a new neural network or weight coefficient is decided, the first hierarchy machine learning/recognizing device is updated at an appropriate timing depending on an operation state of the first hierarchy machine learning/recognizing device. For the update timing, it is desirable to secure communication with the second hierarchy machine learning/recognizing device when rebooted after the first hierarchy machine learning/recognizing device is shut down and describe a program of inquiring about whether or not update data can be downloaded.

The DNN learning is performed in the second hierarchy machine learning/recognizing device, but in a case in which the learning is unable to achieve a desired recognition rate, the learning may be re-executed in the first hierarchy machine learning/recognizing device. In this case, since hierarchization of learning is implemented, there is an effect in that it is possible to perform an efficient operation as a whole.

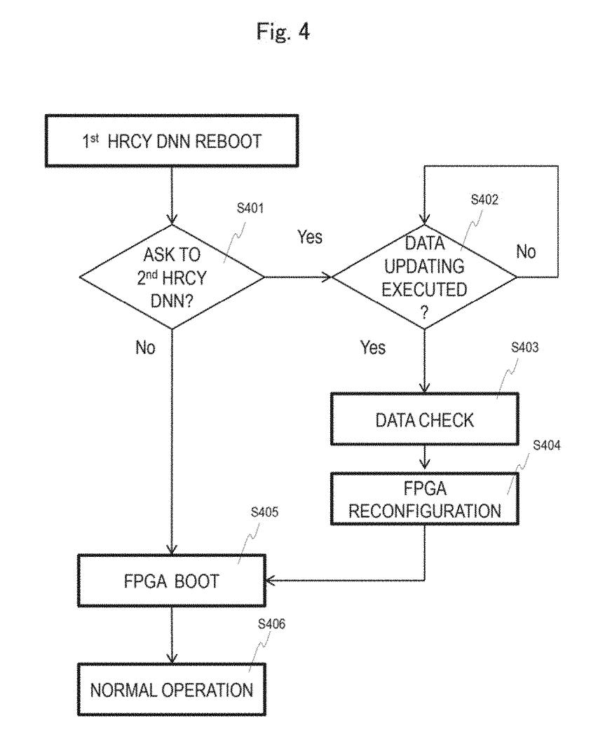

FIG. 4 illustrates a program sequence of changing the configuration of the first hierarchy machine learning/recognizing device. In this case, it is desirable to prepare a protocol for transmitting and receiving requisite minimum data between the first hierarchy machine learning/recognizing device and the second hierarchy machine learning/recognizing device. For example, for example, in a case in which the recognition score in the first hierarchy machine learning/recognizing device drops significantly or in a case in which a periodic update deadline of the neural network or the weight coefficient approach, update request information of the first hierarchy machine learning/recognizing device is transmitted from the first hierarchy machine learning/recognizing device to the second hierarchy machine learning/recognizing device. At a stage at which a learning update process in the second hierarchy machine learning/recognizing device starts, and the updated data is prepared, a data preparation completion signal or update bit information is transmitted to the first hierarchy machine learning/recognizing device. In a situation in which the first hierarchy machine learning/recognizing device is rebooted as a result, the boot sequence illustrated in FIG. 4 is started.

It is determined whether or not data update access to the second hierarchy machine learning/recognizing device is necessary by checking the data preparation completion signal or the update bit information, a data download request signal is transmitted to the second hierarchy machine learning/recognizing device if necessary (S401), it is on standby until the update data is completely downloaded after the arrival of the update data is detected (S402), and it is inspected whether or not the data is normal using a parity or a cyclic redundancy check (CRC) (S403). Thereafter, the configuration information of the FPGA is reconfigured (S404). Thereafter, the FPGA is booted (S405) and the normal operation is started (S406).

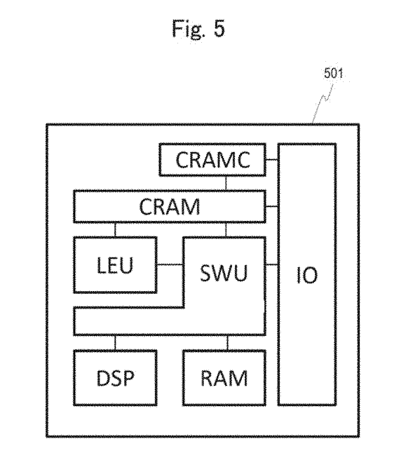

FIG. 5 illustrates a configuration when the DNN is configured with an FPGA, and it is applied to the FPGA 501. A dynamic rewriting technique of a configuration memory (CRAM) in the FPGA is used for reconfiguring the FPGA. The FPGA includes a lookup table unit (LEU), a switch unit (SWU), an operation unit (DSP) which is configured with hardware and performs a product-sum operation and the like, and a memory (RAM).

Logic circuits such as the DNN network of the present embodiment are implemented in the LEU, the SWU, the DSP, and the RAM and perform normal operations. On the other hand, in a case in which the content of the DNN is updated as described above, the update data transmitted from the second hierarchy machine learning/recognizing device can be realized by performing writing to the CRAM through a CRAM control circuit (CRAMC). After the FPGA is reconfigured, the FPGA is started as usual, and the normal operation of the first hierarchy machine learning/recognizing device is performed.

As data between the first hierarchy and the second hierarchy when the machine learning device of the present embodiment is used, the following data is considered:

(1) intermediate layer data generated by the first hierarchy machine learning/recognizing device;

(2) a neural network structure when the machine learning device is configured with the FPGA;

(3) a weight coefficient of an inter-neuron operation;

(4) identification rate and identification score (histogram) information when input data is identified by the first hierarchy machine learning/recognizing device; and

(5) correction information by supervised learning when On the Job Training is performed in the first hierarchy machine learning/recognizing device.

Particularly, in a case in which the first hierarchy machine learning/recognizing device is configured with the FPGA, the data of the intermediate layer stored in the memory, the configuration information of the network (the configuration information describing a switch unit of the FPGA), the weight information, and identification information of identification information obtained by performing the recognition through the first hierarchy learning/recognizing device, and the like are considered to be transmitted to the second hierarchy learning/recognizing device.

Accordingly, high-quality data which is smaller than all input data transmitted to the second hierarchy learning/recognizing device and efficient in learning of the second hierarchy learning/recognizing device is transmitted, and thus there is an effect in that the learning efficiency in the second hierarchy is increased.

According to the configuration of the present embodiment, it is not inevitable to limit the type of neural network using the first hierarchy and the second hierarchy. For example, in a case in which similar networks are formed in the first hierarchy and the second hierarchy, a larger neural network can be constructed as a whole. On the other hand, in a case in which a neural network of an image recognition process is constructed in the first hierarchy, and a neural network of a natural language process is formed in the second hierarchy, there is an effect in that it is possible to perform efficient learning in which the first hierarchy and the second hierarchy cooperate with each other.

### Second Embodiment

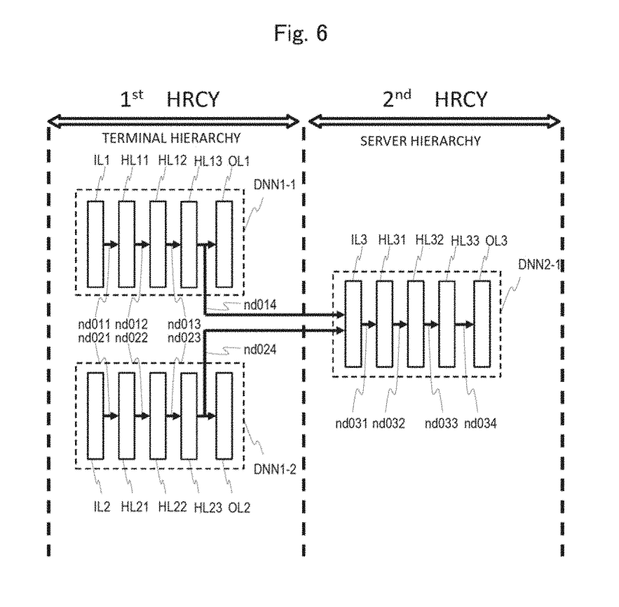

FIG. 6 illustrates an example having a feature in which a unit that transmits data from the second hierarchy machine learning/recognizing device DNN2 to the first hierarchy machine learning/recognizing device DNN1 is not provided. In this example, it is the simplest configuration.

An advantage of this method lies in that the second hierarchy machine learning/recognizing device DNN2 performs the learning and recognition operation using the operation result of the first hierarchy machine learning/recognizing device DNN1, but there is no feedback path from the second hierarchy machine learning/recognizing device DNN2 to the first hierarchy machine learning/recognizing device DNN1, and thus it is possible to configure the first hierarchy machine learning/recognizing device DNN1 and the second hierarchy machine learning/recognizing device DNN2 independently.

The second hierarchy machine learning/recognizing device DNN2 performs the supervised learning using values of hidden layers HL13 and HL23 calculated by the first hierarchy machine learning/recognizing device DNN1 as the input. Therefore, when the learning is repetitively performed in the second hierarchy machine learning/recognizing device DNN2, since the first hierarchy machine learning/recognizing device DNN1 need not perform the operation again, in the learning of the second hierarchy machine learning/recognizing device DNN2, it is not necessary to perform the learning executed by the first hierarchy machine learning/recognizing device DNN1 again, and thus there is an effect in that an operation amount can be reduced as a whole.

Further, learning input data to be input to the second hierarchy machine learning/recognizing device DNN2 is generated and transferred by the first hierarchy machine learning/recognizing device DNN1, and thus there is an effect in that data to be transferred to the second hierarchy machine learning/recognizing device DNN2 is small even in the case of the learning operation.

### Third Embodiment

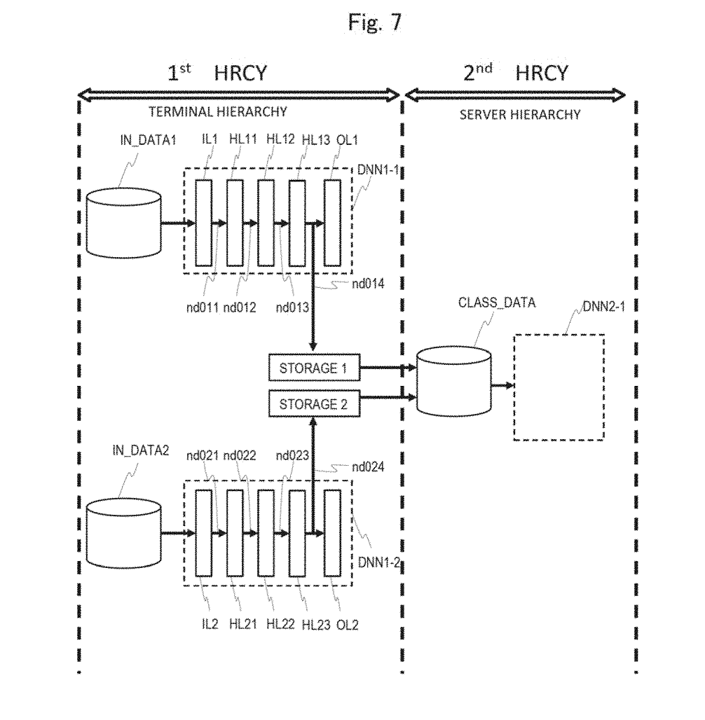

FIG. 7 illustrates a data operation technique in efficiently operating the hierarchy type DNN system of the present embodiment. FIG. 7 illustrates an example in which the recognition process is performed in the first hierarchy machine learning/recognizing device DNN1. In the drawings for describing the following embodiments, for the sake of simplicity, signal lines from an upper-level hierarchy to a lower-level hierarchy is not illustrated, but even when there is a signal connection from the upper-level hierarchy as described in the first embodiment, expansion can be easily performed.

The first hierarchy machine learning/recognizing device DNN1 receives an input from an external sensor device, a database, or the like and executes the recognition process in the DNN1. At this time, the data of the intermediate layer, here, data of nd014 is held in a data storage STORAGE 1 (a HDD, a flash memory, a DRAM, or the like) attached to the DNN1. In the case of the first hierarchy machine learning/recognizing device DNN1, the hardware size is considered to be often limited, and there is a limitation to data storage in this hierarchy. Therefore, in this hierarchy, it is desirable to implement a temporary memory configuration such as a FIFO, and a database Class DATA is constructed in the second hierarchy by transmitting the data to the second hierarchy machine learning/recognizing device DNN2 intermittently.

At this time, if the recognition score information obtained by performing the recognition process in the DNN1 and the neural network configuration information and the weight coefficient information of the DNN1 device are simultaneously stored, the efficiency is good when additional learning is performed in the second hierarchy machine learning/recognizing device DNN2. For example, the neural network information and the weight coefficient information are preferably information which can be mutually recognized in the first hierarchy and the second hierarchy and considered to be shared through data of 64-bit units. Further, in the first hierarchy, it is not necessary to understand the network configuration information or the weight coefficient information in detail, and it is preferable not to forget the network being executed and the weight coefficient information. On the other hand, in the second hierarchy machine learning/recognizing device DNN2, it is necessary to understand a network which is executed by the first hierarchy machine learning/recognizing device DNN1 and a weight coefficient pattern used for executing the network, and thus it is necessary to prepare a correspondence table with the corresponding first hierarchy machine learning/recognizing device DNN1.

Although not illustrated, it is also possible to provide a configuration in which a unit that transfers information from the second hierarchy to the first hierarchy as illustrated in FIGS. 1C and 1D is provided.

### Fourth Embodiment

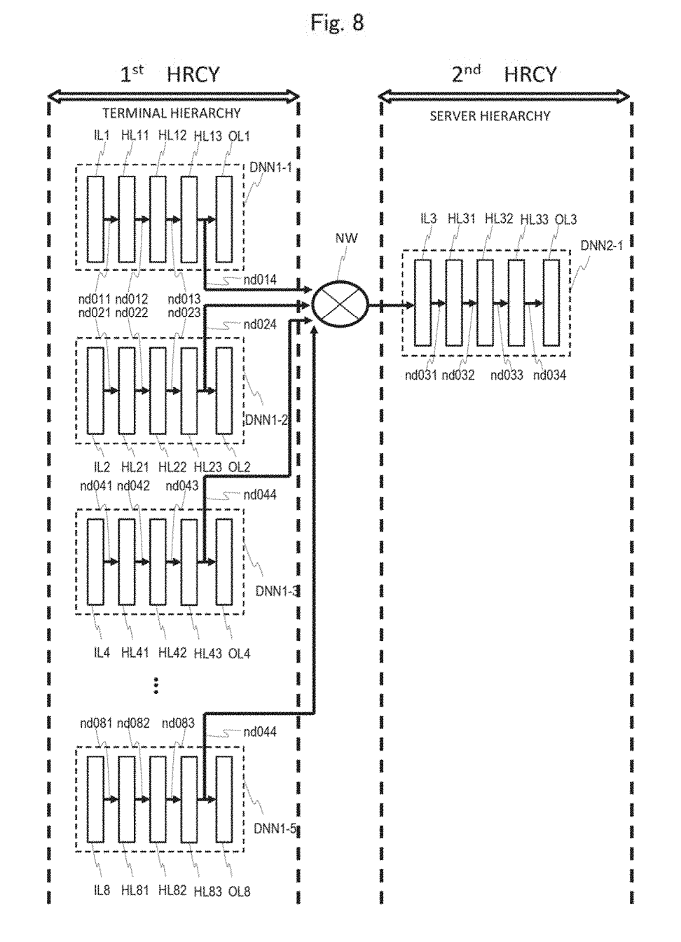

FIG. 8 illustrates an example in which there are three or more first hierarchy machine learning/recognizing devices DNN1. According to the present embodiment, since the first hierarchy machine learning/recognizing devices DNN1 perform the learning and recognition operations independently of one other, it is easy to perform expansion as compared with the learning in the second hierarchy machine learning/recognizing device DNN2 although the number of first hierarchy machine learning/recognizing devices DNN1 is increased.

In the first to third embodiments, for the connection between the first hierarchy and the second hierarchy, only the simple information connection between the two hierarchies has been described, but as the number of first hierarchies increases, an efficient connection method becomes more important. In this embodiment, data is transmitted and received using a network NW. Normally, in the network NW, data is transmitted and received in units of packets, and thus it is possible to transmit a sender address or a receiver address, communication information, and the like together. The network NW can be a wireless network or a wired network, and it is preferable to appropriately connect it depending on a location or a situation of the system.

### Fifth Embodiment

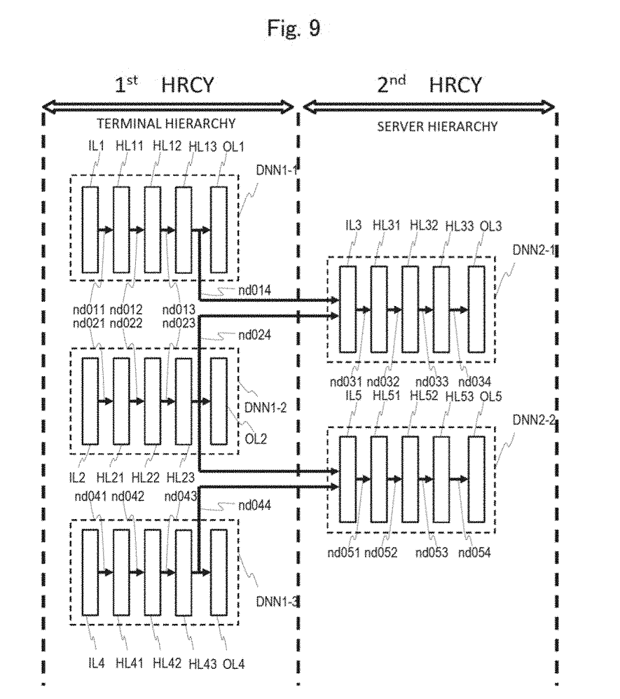

FIG. 9 is a diagram illustrating a modified example. A feature of FIG. 9 lies in that it is possible to share the first hierarchy machine learning/recognizing device DNN1 with different second hierarchy machine learning/recognizing devices DNN2-1 and DNN2-2.

Further, although not illustrated in FIG. 9, when the network NW is formed between the first hierarchy machine learning/recognizing device DNN1 and the second hierarchy machine learning/recognizing device DNN2 as illustrated in FIG. 8, it is possible to establish a connection between the first hierarchy machine learning/recognizing device DNN1 and the second hierarchy machine learning/recognizing device DNN2 flexibly. This is a configuration having a feature in that independent operations are performed in the first hierarchy and the second hierarchy.

With this configuration, it is also possible to configure the entire machine learning network with the machine learning/recognizing devices of the first hierarchy and the second hierarchy.

### Sixth Embodiment

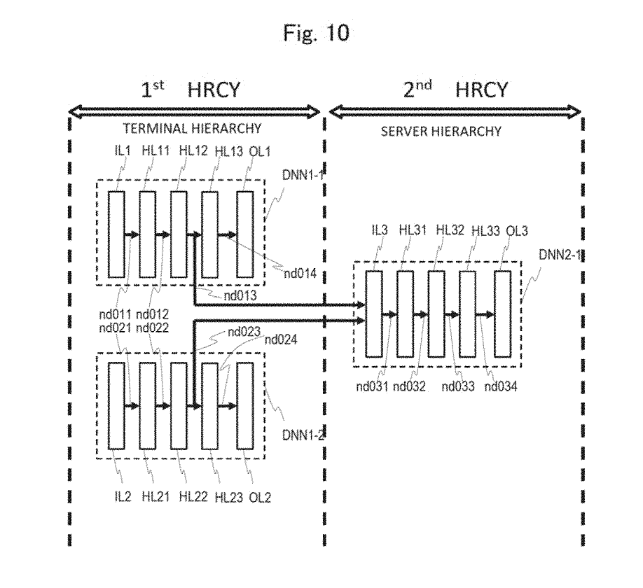

FIG. 10 is a diagram illustrating another modified example. A feature of FIG. 10 lies in that it is possible to transmit data of an optimum layer among a plurality of hidden intermediate layers which are formed as data used as the input from the first hierarchy machine learning/recognizing device DNN1 to the second hierarchy machine learning/recognizing device DNN2. In FIG. 10, outputs of HL12 and HL22 layers are extracted, but the output of HL11, HL21, or the like may not be extracted.

The first hierarchy machine learning/recognizing device DNN1 can set switching of the connection independently of another first hierarchy machine learning/recognizing device DNN1 and the second hierarchy machine learning/recognizing device DNN2.

In this case, for transmission data to the second hierarchy machine learning/recognizing device DNN2, it is desirable to transmit the network structure and the weight coefficient information together with the data of the intermediate layer. The unit described in the first embodiment is preferably used as a unit that transmits and receives data.

It is also possible to set switching of the output data in coordination with another first hierarchy machine learning/recognizing device DNN1 and the second hierarchy machine learning/recognizing device DNN2. In this case, it is it is effective to exchange a signal indicating whether or not a layer in which the transmission data to the second hierarchy machine learning/recognizing device DNN2 is extracted from learning/recognizing accuracy information from another machine learning/recognizing device is switched as an interface between another first hierarchy machine learning/recognizing device DNN1 and the second hierarchy machine learning/recognizing device DNN2.

Further, in a case in which the intermediate layer from which data is output is changed by the second hierarchy machine learning/recognizing device DNN2, it is preferable to evaluate the recognition rate when the learning based on the data is performed and execute output control switching control of a relevant first machine learning/recognizing device group.

Accordingly, there is an effect in that it is possible to provide a flexible learning/recognizing system corresponding to an ever-changing environment. Further, there is an effect in that it is possible to improve the efficiency of recognition and learning by appropriately changing data acquisition, learning, and recognition during an actual operation on the basis of actual data for optimization that is put into a design.

### Seventh Embodiment

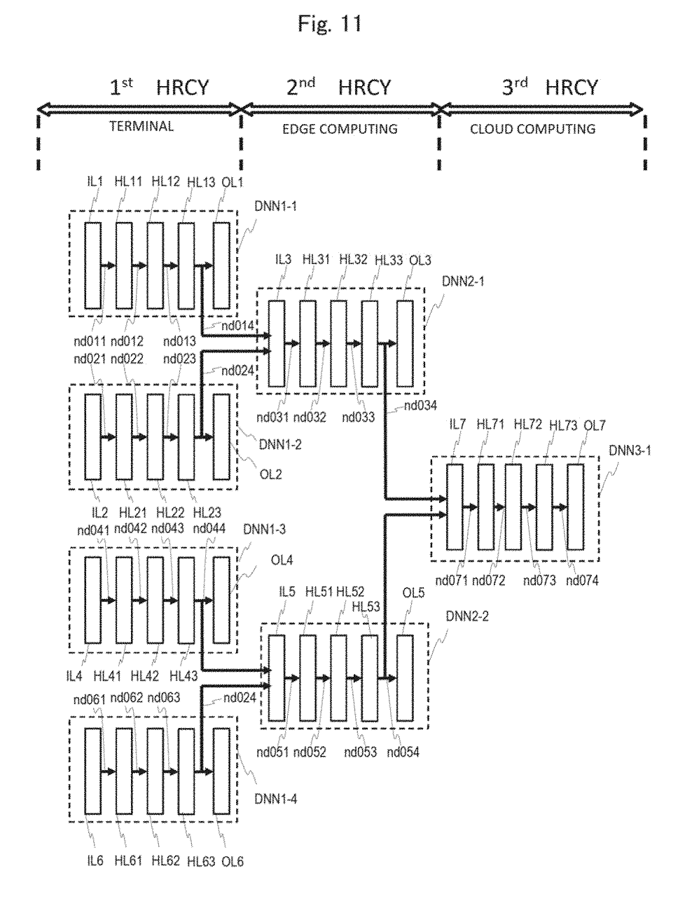

FIG. 11 illustrates an example in which operation hierarchies are installed in three hierarchies. The reason for installing a plurality of operation hierarchies is because an operation capability and efficiency are considered. The first hierarchy machine learning/recognizing device DNN1 is designed to be installed in an embedded system, and a very compact implementation is required, a power constraint is large, and a large amount of operation is unable to be expected.

On the other hand, in the case of the operations of the second and third hierarchies DNN2 and DNN3, a constraint of an operation hardware is loose, and it is possible to perform a large-scale high-speed operation using merits such as enlargement and power restriction relaxation.

Generally, in the case of a hierarchy called “cluster computing,” an installation place is unclear, and an equipment installed on the back side of the earth is used according to circumstances. In this case, there is a problem in that it is difficult to perform real-time control due to a delay caused by influence of a physical distance, a delay when passing through a network gateway (various gateways and router devices) or a connection to a cloud server, and the like.

In this regard, when a medium-sized second hierarchy DNN2 and a hierarchy in which a low latency and a high-speed high-capacity operation are implemented are installed before the third hierarchy DNN3 according to the cloud computing, the improvement may be obtained. In this case, there is an effect in that it is possible to efficiently distribute a load.

### Eighth Embodiment

In the following embodiments, an example in which the first hierarchy machine learning/recognizing device does not include the learning function.

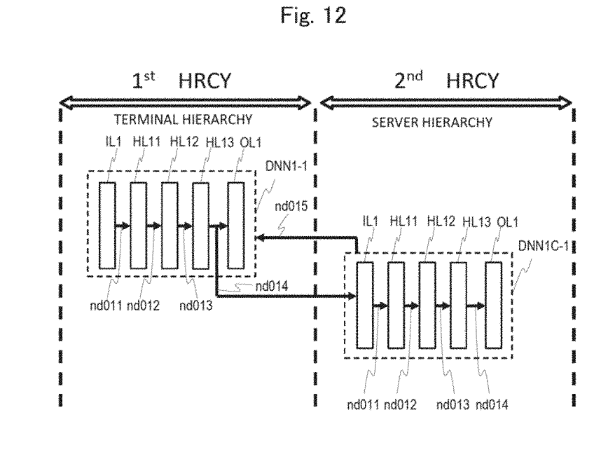

In the example illustrated in FIG. 12, the second hierarchy machine learning/recognizing device is caused to have a copy DNN1C of the neural network structure and the weight coefficient information of the first hierarchy machine learning/recognizing device DNN1, and the second hierarchy machine learning/recognizing device is caused to execute the learning operation.

The neural network structure and the weight coefficient information of the learning result are caused to be appropriately reflected in the first hierarchy machine learning/recognizing device DNN1 through data nd015.

According to the present embodiment, there is an effect in that it is possible to reduce the functions of the terminal side and reduce a quantity of hardware to be mounted. Further, there is an effect in that it is possible to reduce a time taken for the learning of the first hierarchy machine learning/recognizing device DNN1 by learning through the high-performance second hierarchy machine learning/recognizing device.

For the learning operation in the second hierarchy machine learning/recognizing device DNN1C, the value of the hidden layer is calculated by the first hierarchy machine learning/recognizing device DNN1, and a result nd014 is input to the second hierarchy machine learning/recognizing device DNN1C, and the supervised learning is performed by the second hierarchy machine learning/recognizing device DNN1C.

The learning in the second hierarchy is repetitively performed using the intermediate layer data of the first hierarchy machine learning/recognizing device DNN1. The data such as the neural network structure and the weight coefficient obtained as the learning result in the second hierarchy machine learning/recognizing device DNN1C is transmitted to the first hierarchy machine learning/recognizing device DNN1 at an appropriate timing. In the first hierarchy machine learning/recognizing device DNN1, after the updated configuration information is reflected, the recognition process is executed.

As described above, it is not necessary to perform the operation again in the first hierarchy machine learning/recognizing device DNN1 when the learning of the second hierarchy machine learning/recognizing device is repeated, and thus there is a merit in that it is possible to implement labor-saving such as a reduction in an operation amount at the time of learning and device size reduction.

### Ninth Embodiment

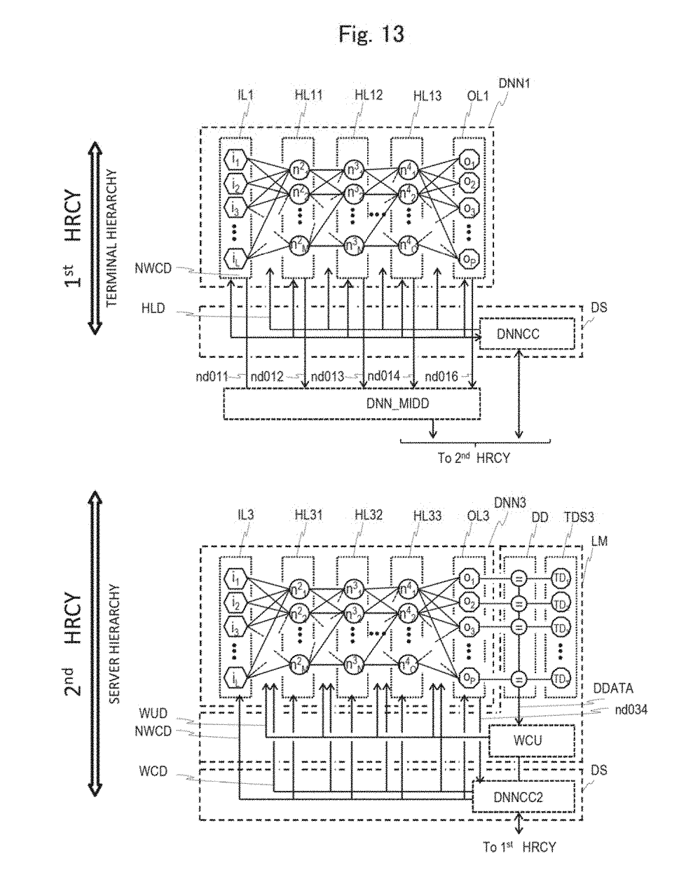

Another modified example of the learning technique is described with reference to FIG. 13. In this example, as described in the eighth embodiment, the learning function of the first hierarchy machine learning/recognizing device DNN1 is not used during the normal recognition operation, but the learning is performed at a timing such as a timing at which initialization or update is performed.

A copy of the first hierarchy machine learning/recognizing device is held in the second hierarchy machine learning/recognizing device, and the learning is performed in the second hierarchy machine learning/recognizing device, and then the neural network structure, the weight coefficient, and the like are reflected in the first hierarchy machine learning/recognizing device.

After a new neural network structure or new weight coefficient information is updated in the first hierarchy machine learning/recognizing device, the supervised learning is performed in the first hierarchy machine learning/recognizing device, and then the supervised learning is performed in the entire system including the first hierarchy and the second hierarchy using the data of the learning result as an initial value as described above in the first embodiment.

With this configuration, there is an effect in that the learning is easier than in a case in which each of the first hierarchy machine learning/recognizing device and the second hierarchy machine learning/recognizing device are configured with a single deep neural network, and the learning is performed.

Further, similarly to other basic examples described above, since the value is extracted from the hidden layer other than the output layer of the first hierarchy machine learning/recognizing device, a more amount of information is input to the DNN of the server. As compared with the basic example, it is unable to be used only in the first hierarchy machine learning/recognizing device, but there is an effect in that it is possible to implement the optimization as the entire system including the first hierarchy and the second hierarchy.

### Tenth Embodiment

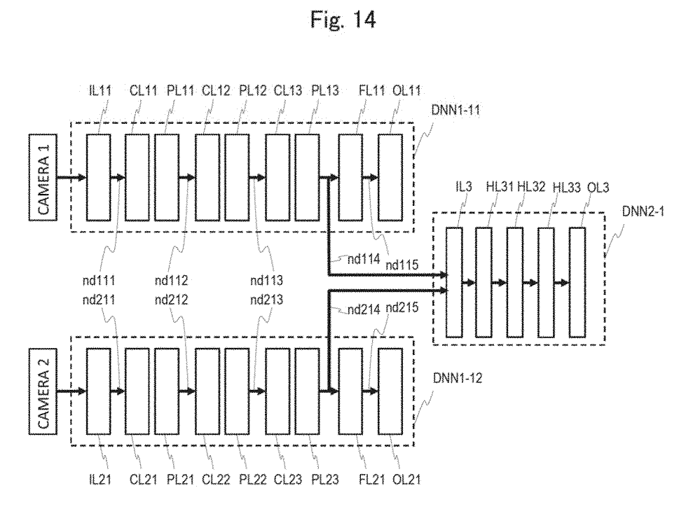

FIG. 14 illustrates a specific example when applied to the convolutional neural network (CNN). In the case of the CNN, the hidden layer includes a convolution layer (CL) and a pooling layer (PL), and a plurality of combinations thereof are provided. In this case, data of the hidden layer is data such as nd111 to nd115.

In this example, the same target is imaged through a plurality of cameras, and an image recognition process is executed. Since a video captured by a camera 1 and a video captured by a camera 2 differ in position, the shapes of the subject are different although the same subject is imaged. Therefore, it is efficient since it is possible to acquire information at the same time under different conditions such as a photographing angle or a radiation degree of light rays and perform the recognition and the learning.

Further, since image information of a subject of interest and a background subject change in accordance with a positional deviation or the like, it is possible to improve the efficiency of the learning such as the calculation of the weight coefficient in extracting information about feature quantity extraction.

At this time, it is possible to input information with positional information to the second hierarchy machine learning/recognizing device DNN2 by transmitting the information before perfect coupling layers FL11 and FL21 to the second hierarchy machine learning/recognizing device DNN2, and it is possible to implement more advanced learning by performing an operation of combining interim data of a plurality of first hierarchy machine learning/recognizing devices DNN1 using a plurality of cameras and a CNN recognition process. Further, by providing position information and time synchronization information at the same time, an analysis information for a recognition object serving as a target increases, and thus there is an effect in that it is possible to implement learning for implementation of more accurate recognition.

In the present embodiment, it is considered that the first hierarchy machine learning/recognizing device DNN1 is configured with the FPGA, and the second hierarchy machine learning/recognizing device is configured with the device including the CPU and the GPU. CNN decomposes the input image into small pixel blocks (called kernels) due to its structure, and carries out an inner product operation with the weight coefficient matrix corresponding to the same number of pixels while scaling an original image in those units. For the internal operation, a parallel process in hardware is effective, and an implementation by an FPGA including a large number of operation units and memories in an LSI is low in power consumption and high in performance and very efficient. On the other hand, in the second hierarchy, it is effective to cause a plurality of operation units to efficiently perform a distributed operation on data from a plurality of first hierarchies as a batch process, and it is desirable to use a low-cost distributed operation system using a software process. It can be easily applied to various DNNs as in this example.

### Eleventh Embodiment

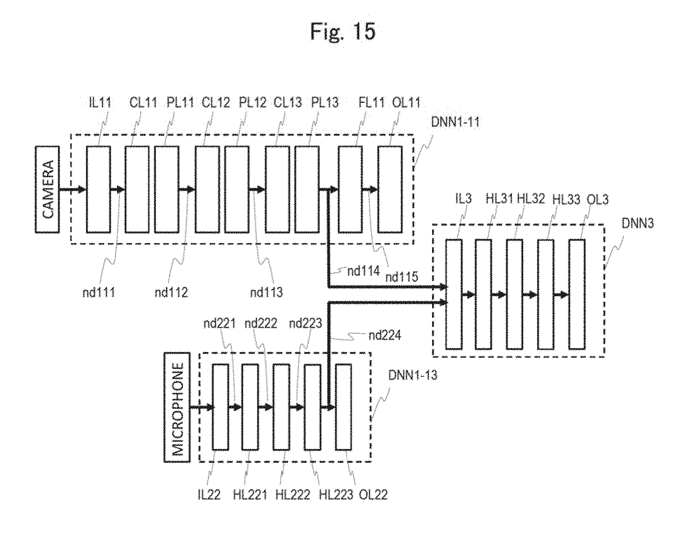

FIG. 15 is an example of an application to a machine learning system using different sensors (for example, a camera and a microphone). In this case, it is a system in which a neural network DNN1-11 of image processing and a neural network DNN1-13 of audio processing are fused. In a case in which recognition of a robot or the like is considered, if both an image and a voice are characterized together, it is considered to be effective in various recognitions. This is because, in a case in which a human understands an object, if visual information and auditory information are combined, the information amount is dramatically increased as compared with a case in which either of the visual information and the auditory information is used, and thus the recognition efficiency is high.

Further, in this example, the image may be processed by the CNN, and the sound may be configured by an all-coupling neural network. As described above, it is a configuration for improving the recognition rate by combining advantages using the neural networks of various systems other than a uniform neural network. In this case, since the learning can be performed separately, there is an effect in that the learning is easy although the system is complicated.

### Twelfth Embodiment

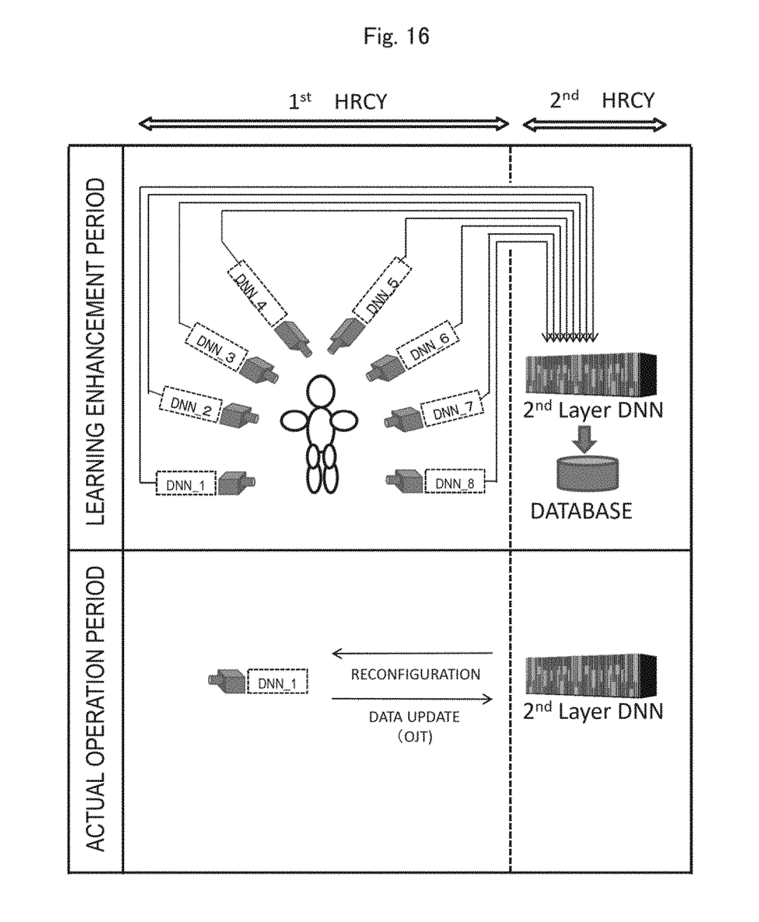

FIG. 16 illustrates a system application and an operation method of the present embodiment including a database construction system for object recognition using the system.

The example in which for image information, information from a plurality of first hierarchy machine learning/recognizing devices is transmitted to the second hierarchy machine learning/recognizing device, and the efficient learning is performed in the second hierarchy machine learning/recognizing device as illustrated in FIG. 14 (the tenth embodiment) has been described.

As an application thereof, it is effective to enhance learning for a certain object, construct a database thereof, and improve the learning efficiency and the recognition efficiency of the second hierarchy machine learning/recognizing device.

In this case, the recognition and the learning for one object are performed in a plurality of first hierarchy machine learning/recognizing devices at the same time, and the hidden layer data calculated by the first hierarchy machine learning/recognizing device is transmitted to the second hierarchy machine learning/recognizing device.

In this embodiment, first of all, as the example of the image recognition, a configuration for simultaneously observing a plurality of systems configured with the camera serving as the sensor and the first hierarchy machine learning/recognizing devices DNN 1 to DNN 8 that recognize and analyze output data thereof is described. In FIG. 14, the eight first hierarchy machine learning/recognizing devices are illustrated, and in the present invention, although the number of first hierarchy machine learning/recognizing devices is not limited, it is possible to operate them.

As described above, the recognition target is observed multidirectionally, a basic operation and features are extracted, the operation and the features are further analyzed in the second hierarchy machine learning/recognizing device, and the neural network structure and the weight coefficient for extracting the operation or the feature of the observation target well are extracted and stored as a database.

According to the present invention, the target is not limited to the image data, but data from various angles such as audio information, temperature information, smell information, and texture information (hardness and composition) can be dealt as the input, and after information processing is performed in the first hierarchy machine learning/recognizing device, the efficient information is transmitted to the second hierarchy machine learning device, and further detailed learning and recognition of multisensory cooperation is performed.

As described above, detailed observation is carried out at the laboratory level during the learning enhancement period. Further, it is necessary to provide a result for an actual operation. The period is defined as an actual operation period. During this period, reconfiguration data is transferred from the second hierarchy machine learning/recognizing device to the first hierarchy machine learning/recognizing device, and the first hierarchy machine learning/recognizing device is set to implement efficient recognition even as a single body.

In this situation, the operation is carried out on the basis of the first embodiment of the present application, for example, the recognition result for the ever-changing environment is appropriately transmitted to the second hierarchy machine learning/recognizing device, and further data collection for efficient recognition is performed.

By constructing such a system, the quality of initial data (a high recognition rate, an efficient neural network form, or the like) can be increased when used in the actual operation period, and thus an effect of reducing a failure in the market can be expected.

### Thirteenth Embodiment

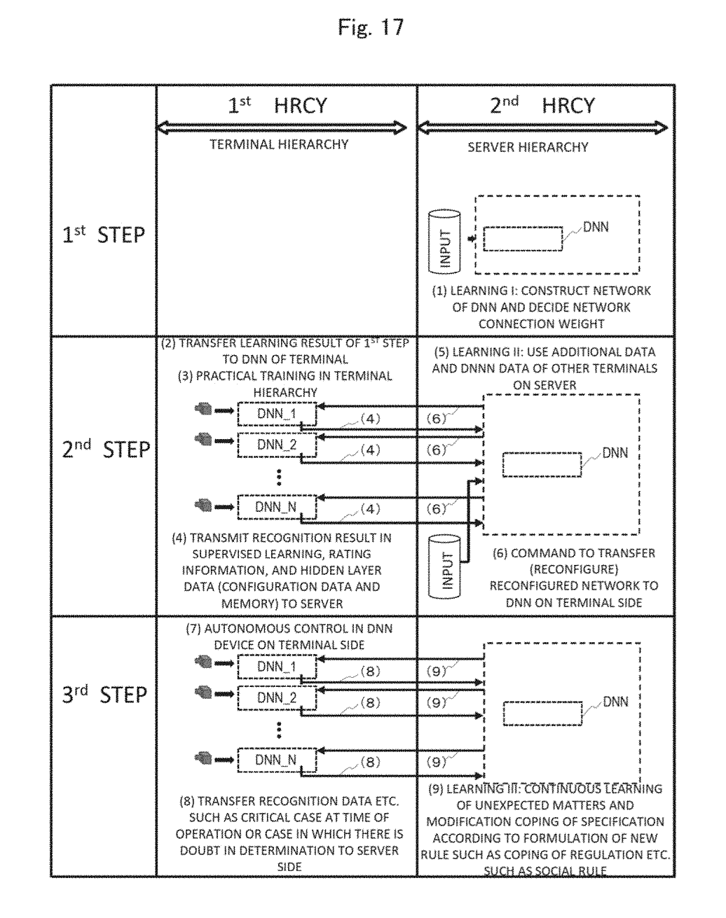

An example of a commercial application will be described with reference to FIG. 17. In this embodiment, as an assumption, the first hierarchy machine learning/recognizing devices DNN 1 to DNN N are assumed to be small learning/identifying machines, and the second hierarchy machine learning/recognizing device DNN is assumed to be a large learning machine.

As a first step, the learning in the second hierarchy machine learning/recognizing device DNN is performed. Since this is a first learning phase (learning I), the learning in the second hierarchy machine learning/recognizing device DNN which is rich in computational resources is efficient. In this case, the input data is learned on the basis of data according to an operation situation executed in in a second step. For example, in a case in which automatic driving or the like is considered, video data or the like obtained by a camera installed in a vehicle may be considered. In a sense, data under limited circumstances is used in this level of learning, and the learning in which the data amount is limited is performed, but it is regarded as the learning of constructing the basic configuration for constructing the basic DNN network of the first hierarchy machine learning/recognizing device.

The second step will be described. The identifying machine is installed in the first hierarchy machine learning/recognizing devices DNN 1 to DNN N, and the recognition and the learning (supervised learning) by the practical training under the actual operation situation is performed. The learning at this stage corresponds to the practical training for acquiring a driving license when a driver license is acquired.

In this step, first, it is a main purpose to collect data for improving the recognition rate, and it is an object to detect an estrangement situation with the training data for the DNN constructed in the first step. For example, when it is applied to an automatic driving system, it is installed in an actual vehicle, determination of a driver (human) is used as the training data, the estrangement is indicated by a score, and the data collection is performed. In this case, the hidden layer data from DNN 1 to DNN N are appropriately transmitted to the second hierarchy machine learning/recognizing device DNN, learning is further performed by the second hierarchy machine learning/recognizing device DNN, the update data is reflected in the first hierarchy machine learning/recognizing devices DNN 1 to DNN N, and the supervised learning is further performed in the first hierarchy machine learning/recognizing devices DNN 1 to DNN N.

At this time, particularly, if a state in which the score is good, a case in which the score is bad, or a case in which there is a doubt in the determination are sorted and organized, and it is transmitted to the second hierarchy machine learning/recognizing device DNN, the second hierarchy machine learning/recognizing device DNN can perform multidirectional learning while using the information.

Finally, a third step is described. This step corresponds to a case in which the identifying machines of the first hierarchy machine learning/recognizing devices DNN 1 to DNN N are sufficiently learned and is a stage in which control authority is given. In this stage, the first hierarchy machine learning/recognizing device performs the recognition process mainly without performing the learning. Here, a simple check mechanism of comparing basic matters with the training data and holding a level of a comparison result is installed, it is appropriately transferred to the second hierarchy machine learning/recognizing device DNN, and the learning is continuously performed by the second hierarchy machine learning/recognizing device DNN.

As described above, since the machine learning system is also continuously updated, the advanced control such as the automatic driving can be implemented.

### Fourteenth Embodiment

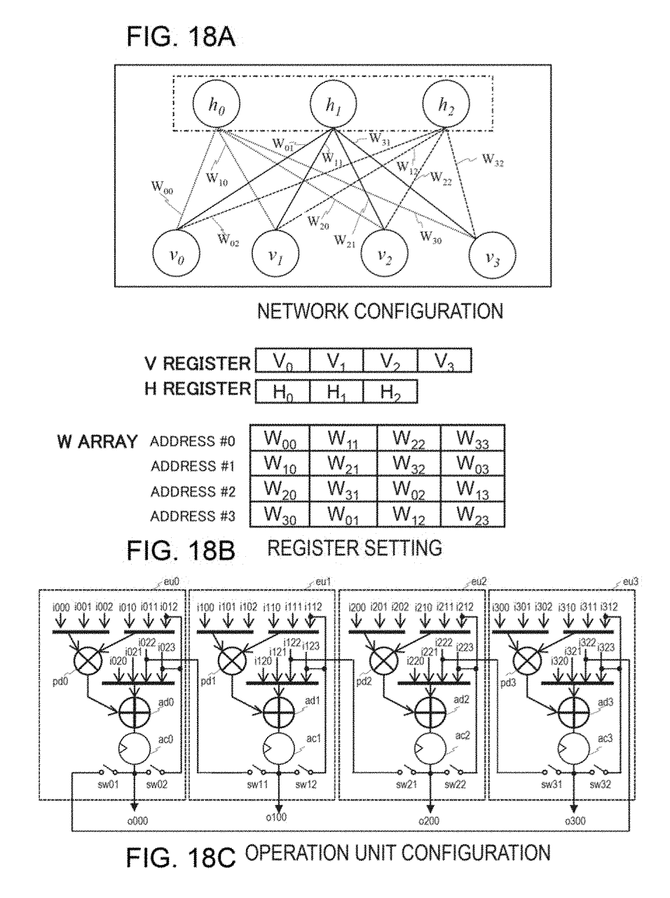

FIGS. 18A to 18C are examples in which the perfect coupling layer of the neural network is implemented by an FPGA. It is a connection type used in the neural networks such as the final output layer of the CNN system or a Gaussian restricted Boltzmann machine (GRBM) system, but it is necessary to implement highly efficient in FPGA. Particularly, the operation of the connection from the lower layer (visible layer) to the upper layer (hidden layer) and the operation from the upper layer (hidden layer) to the lower layer (visible layer) differ in the operation order of the weight coefficient. In order to perform the operation in both from the lower layer to the upper layer and from the upper layer to the lower layer at a high speed, it is necessary to optimally arrange the weight coefficient so that the reading of both is performed at a high speed.

In other words, in the operation related to the conversion from the lower layer to the upper layer, if a weight coefficient matrix is indicated by W, the inner product operation of the following Formula (1) is necessary,

H=W·V (1)

but in the operation from the upper layer to the lower layer, the inner product operation with a transposed matrix of W of the following Formula (2) is necessary.

V=W^{T}·H (2)

The operation will be described specifically using the network illustrated in FIG. 18A as an example.

Here, the lower layer includes four nodes Vo to V3, the upper layer includes three nodes h0 to h2, all the nodes of the lower layer are connected to the nodes of the upper layer, and the connection serves as an operation of obtaining a value of a node on an output side by multiplying a value of a node on an input side by a weight function.

In other words, since the configuration in which the layers can be perfectly connected by the four nodes of the lower layer and the three nodes of the upper layer is provided, the weight coefficient has a value of 4×4=16. If this value is expressed in a matrix form, it is indicated by a 4×4 matrix. It is clear from Formulas (1) and (2) that an operation of transposing the W matrix is necessary between the two formulas, and in a case in which it is configured with hardware, if the speed increase is considered, it is necessary to place it in a memory optimized for the operation. In other words, in a case in which Formulas (1) and (2) are calculated, it is necessary to prepare a register and a memory for the independent W matrix in both.

However, since the weight coefficient becomes a matrix with a very large dimension, if such two matrices are prepared, and the operation is performed, it is particularly disadvantageous in the first hierarchy machine learning/recognizing device in terms of cost. In this regard, a memory configuration of holding the weight coefficient to reduce an area while maintaining the high-speed operation becomes important.

A unit of implementing it generally becomes the following matrix expression as illustrated in FIG. 18B when the weight coefficient is first stored.

$$( \begin{matrix}{W}_{00} , {W}_{01} , {W}_{02} , {W}_{03} \\ {W}_{10} , {W}_{11} , {W}_{12} , {W}_{13} \\ {W}_{20} , {W}_{21} , {W}_{22} , {W}_{23} \\ {W}_{30} , {W}_{31} , {W}_{32} , {W}_{33}\end{matrix} ) \qquad [ Math . 1 ]$$

It is written as above, and it is described in a shifted form as illustrated in FIG. 18B. At the same time, as an operation circuit, it is advantages that a path entering a multiplying unit and an adding unit arranged in a path in which an operation result of the present circuit is input to an accumulator and a path entering a multiplying unit and an adding unit of a neighbor product-sum operation circuit are formed in an input selector unit in a product-sum operation circuit illustrated in FIG. 18C.

Here, four operation units (eu0 to eu3) are illustrated. An example in which each operation unit includes a multiplying unit (pd0 to pd3), an adding unit (ad0 to ad3), and an accumulator (ac0 to ac3), and for an input of the adding unit, a first input is three inputs (i000,i001,i002), and a second input is (i010,i011,i012) by a selector, and for the input of the adding unit, an output of the multiplying unit is used as the first input, and four inputs (i020,i021,i022,i023) switchable by the selector are used as the second input is illustrated. Here, an example in which i020 is “0,” i021 is an input from a register, i022 is an accumulator output, and i023 shares a part of a multiplying unit input (i012) and an input.

An operation method is as follows. (1) In a case in which the value of the upper layer from the lower layer is obtained:

Data input to a V register is input to each adding unit (I010, i020, i030, i040), a weight coefficient of a corresponding W array is input to the multiplying unit (i000, i100, i2000, i300), and after multiplication is performed, “0” is initially input to “i020, i120 i220 i320.” Then, the value of the V register is shifted (rotated) to the left, and the value of the corresponding V register is input to the multiplying unit. Accordingly, data of an address at which the address of the W register is actually incremented can be input to the multiplying unit. After the multiplication, sw01, sw11, sw21, and sw31 are turned OFF, sw02, sw12, sw22, and sw32 are turned ON, and the data stored in the accumulator is input to the adding unit and added. This is performed on all. As a result,

V₀*W₀₀+V₁*W₁₀+V₂*W₂₀+V₃*W₃₀ (3)

V₀*W₀₁+V₁*W₁₁+V₂*W₂₁+V₃*W₃₁ (4)

V₀*W₀₂+V₁*W₁₂+V₂*W₂₂+V₃*W₃₂ (5)

is obtained. Since a result of a neighbor operation unit is not used in this mode, it is called a self-operation mode.

(2) In a case in which the value from the upper layer to the lower layer is obtained:

In this case, the data stored in the accumulator is transferred to the adding unit of the neighbor product-sum operation circuit, and a diagonal shift operation of the W array is actually executed.

First, information of an address #3 is read from the W array and input to the multiplying unit (i000, i100, i2000, i300). A corresponding unit of an H register is input to the multiplying unit (i010, i020, i030), the multiplication is then performed, and “0” is initially added and stored in the accumulator. In a second or later try, the stored data of the accumulator is input to the addition circuit of the neighbor operation unit, and thus sw01, sw11, sw21, and sw31 are turned on, sw02, sw12, sw22, and sw32 are turned off, and then the operation is performed.

Even in the first operation, if the accumulator is reset, an actual “0” addition can be performed by inputting the accumulator output of the neighbor product-sum operation circuit.

The above operation is repeated, and the following is obtained.

H₂*W₃₂+H₁*W₃₁+H₀*W₃₀ (6)

H₀*W₀₀+H₂*W₀₂+H₁*W₀₁ (7)

H₁*W₁₁+H₀*W₁₀+H₂*W₁₂ (8)

H₂*W₂₂+H₁*W₂₁+H₀*W₂₀ (9)

Since the result of the operation unit is used in this mode, it is called a mutual operation mode.

Since the operation is performed as described above, the high-speed operation can be performed in the saved area in a case in which the operation of the upper layer from the lower layer is performed as well as in a case in which the operation of the lower layer from the upper layer is performed.

In the above embodiment, the example in which the DNN device is hierarchized, and the terminal side processing unit and the server side processing unit are provided has been described above. Further, the example in which the input data on the terminal side or the intermediate layer data of the DNN when the recognition is performed on the terminal side is transmitted to the server side, the learning is performed on the server side, and the learning result of the server is transmitted to the terminal side at an appropriate timing, and the recognition operation is performed in the terminal has been described. The data output of the intermediate layer of the DNN of the terminal is used as the input of the DNN on the server side, and the learning is performed in the DNN in each hierarchy. As the learning method, the supervised learning of the DNN of the terminal is performed, and then the supervised learning of the DNN of the server is performed. The DNN device on the terminal side is configured with a small-sized compact low-power device, and the DNN device on the server side is configured with a so-called server which is able to perform the high-speed operation and includes a large capacity memory.

According to the embodiments described in detail above, since the value from the hidden layer other than the output layer of the DNN of the terminal is acquired, a more amount of information can be the input of the DNN of the server, and thus there is an effect in that it is possible to perform the efficient learning as a whole.

Further, since the hierarchical learning is performed, there is an effect that it is possible to reduce the learning period of time and facilitate the learning itself as compared with the case in which a single DNN is used as a whole.

Further, in a case in which a cooperative operation of a plurality of terminals using IoT is considered, a control variable initially considered by a designer is necessarily not optimal, but since the hierarchical DNN is configured between a plurality of terminals and the server in which it is difficult to implement such optimization, there is an effect in that it is possible to implement the optimization as a whole.

The present invention is not limited to the embodiments described above but includes various modifications. For example, it is possible to replace a part of a configuration of a certain embodiment with a configuration of another embodiment, and it is also possible to add a configuration of another embodiment to a configuration of a certain embodiment. It is also possible to perform addition, deletion, and replacement of configurations of other embodiments on a part of the configurations of each embodiment.

### INDUSTRIAL APPLICABILITY

The present invention can be used in general technical fields to which the machine learning can be applied, for example, in fields of social infrastructures.

### REFERENCE SIGNS LIST

1^{st} HRCY first hierarchy machine learning/recognizing device
2^{nd} HRCY second hierarchy machine learning/recognizing device
3^{rd} HRCY third hierarchy machine learning/recognizing device
IL input layer
HL hidden layer
OL output layer
DNN deep neural network type machine learning/recognizing unit
WUD weight coefficient change line (wait coefficient update (WUD))
NWCD neural network configuration information data transmission line
WCD weight coefficient change line
WCU weight coefficient adjusting circuit (weight change unit (WCU))
DNNCC DNN network configuration control unit
DDATA detection data
LM learning module
DD error detecting unit (deviation detection (DD))
TDS training data
DS data storage unit
nⁱⱼ i-th layer j-th node
ndⁱ_{j,k} connection line of i-th layer j-th node and (i+1)-th layer k-th node
AU arithmetic operation unit
wⁱ_{j,k} weight coefficient when value of (i+1)-th layer k-th node is calculated using i-th layer j-th node as input
DNN# identification number of DNN network mounted in first hierarchy machine learning/recognizing device
WPN# pattern number of weight coefficient of DNN network mounted in first hierarchy machine learning/recognizing device RES_COMP
Det_rank ranking information of detection result
UD Req update request issue information of neural network of first hierarchy machine learning/recognizing device
UD Prprd update completion information of neural network of first hierarchy machine learning/recognizing device
CRAM configuration information storage memory of FPGA
LEU lookup table storage unit
SWU switch unit
DSP arithmetic operation hard operation unit
RAM FPGA internal memory
IO data input/output circuit unit
IN_DATA input data of first hierarchy machine learning/recognizing device
STORAGE data transfer temporary storing data accumulating unit from first hierarchy machine learning/recognizing device to second hierarchy machine learning/recognizing device
CLASS_DATA database that accumulate information transmitted from plurality of first hierarchy machine learning/recognizing device from first hierarchy
NW network
CL11 convolution layer
PL11 pooling layer
FL11 perfect coupling layer

1. An information processing system, comprising:
a plurality of DNNs which are hierarchically configured,
wherein data of a hidden layer of a DNN of a first hierarchy machine learning/recognizing device is used as input data of a DNN of a second hierarchy machine learning/recognizing device.

2. The information processing system according to claim 1, wherein, after supervised learning is performed in the DNN of the first hierarchy machine learning/recognizing device so that an output layer performs a desired output, supervised learning of the DNN of the second hierarchy machine learning/recognizing device is performed.

3. The information processing system according to claim 1, wherein the first hierarchy machine learning/recognizing device includes a unit that stores a score of a recognition result of a recognition process while performing the recognition process and an update request transmitting unit that transmits an update request signal for a neural network structure and a weight coefficient of the DNN of the first hierarchy machine learning/recognizing device to the second hierarchy machine learning/recognizing device in a case in which the recognition result is larger than a predetermined threshold value 1 or smaller than a predetermined threshold value 2 or in a case in which a variance when a histogram of the recognition result is generated is larger than a predetermined value,
upon receiving the update request signal of the first hierarchy machine learning/recognizing device, the second hierarchy machine learning/recognizing device updates the neural network structure and the weight coefficient of the DNN of the first hierarchy machine learning/recognizing device, and transmits update data to the first hierarchy machine learning/recognizing device, and
the first hierarchy machine learning/recognizing device constructs a new neural network on the basis of the update data.

4. The information processing system according to claim 1, wherein the first hierarchy machine learning/recognizing device includes
a learning module that performs a learning process,
a storage unit that stores weight coefficient information of a learning result of the learning process, recognition result rating information, and intermediate layer data information, and
a unit that transmits the update request signal to the second hierarchy machine learning/recognizing device in a case in which it is necessary to update the neural network of the first hierarchy machine learning/recognizing device.

5. The information processing system according to claim 1, wherein a connection of the first hierarchy machine learning/recognizing device and the second hierarchy machine learning/recognizing device has only an input from the first hierarchy machine learning/recognizing device to the second hierarchy machine learning/recognizing device.

6. The information processing system according to claim 1, wherein the first hierarchy machine learning/recognizing device includes a storage device that temporarily holds a value of the hidden layer of the DNN and a mechanism that holds data of the storage device in the second hierarchy machine learning/recognizing device as an input data database.

7. The information processing system according to claim 1, wherein there are a plurality of first hierarchy machine learning/recognizing devices, and the plurality of first hierarchy machine learning/recognizing devices are connected directly or via a network using at least one of a wired manner and a wireless manner for transmission of the input data from the plurality of first hierarchy machine learning/recognizing devices to the single second hierarchy machine learning/recognizing device.

8. The information processing system according to claim 1, wherein there are a plurality of second hierarchy machine learning/recognizing devices, and
data of the hidden layer data from one of the first hierarchy machine learning/recognizing devices is shared by the plurality of second hierarchy machine learning/recognizing devices.

9. The information processing system according to claim 1, wherein a copy of the DNN of the first hierarchy machine learning/recognizing device is installed in the second hierarchy machine learning/recognizing device, and
together with learning or a recognition process in with the first hierarchy machine learning/recognizing device,
in the second hierarchy machine learning/recognizing device, learning is performed on the basis of input data from the first hierarchy machine learning/recognizing device, and as a result, configuration information of a neural network and weight coefficient information which are a learning result in the second hierarchy machine learning/recognizing device is transmitted to the first hierarchy machine learning/recognizing device, and the neural network and a weight coefficient of the first hierarchy machine learning/recognizing device are updated.

10. The information processing system according to claim 1, wherein a hardware size of the second hierarchy machine learning/recognizing device is larger than a hardware size of the first hierarchy machine learning/recognizing device.

11. A method for operating an information processing system including a plurality of DNNs, comprising:
configuring the plurality of DNNs to have a multi-layer structure including a first hierarchy machine learning/recognizing device and a second hierarchy machine learning/recognizing device;
wherein information processing capability of the second hierarchy machine learning/recognizing device higher than information processing capability of the first hierarchy machine learning/recognizing device is used, and
data of a hidden layer of a DNN of the first hierarchy machine learning/recognizing device is used as input data of a DNN of the second hierarchy machine learning/recognizing device.

12. The method for operating the information processing system according to claim 11, wherein a configuration of a neural network of the first hierarchy machine learning/recognizing device DNN is controlled on the basis of a processing result of the second hierarchy machine learning/recognizing device.

13. The method for operating the information processing system according to claim 11, wherein one inspection target is observed using a plurality of first hierarchy machine learning/recognizing devices,
the data of the hidden layer of the first hierarchy machine learning/recognizing device obtained in a process of the observation is transferred to the second hierarchy machine learning/recognizing device,
in the second hierarchy machine learning/recognizing device, learning is performed on the basis of the data of the hidden layer, and a database for calculating a neural network structure and a weight coefficient of the first hierarchy machine learning/recognizing device is constructed,
the learning and the construction period of the database in the second hierarchy machine learning/recognizing device are defined as a learning enhancement period of the first hierarchy machine learning/recognizing device, and
the second hierarchy machine learning/recognizing device has an operation form of defining an actual operation period in which the neural network and the weight coefficient of the first hierarchy machine learning/recognizing device are set, and an operation of recognition learning is performed in the first hierarchy machine learning/recognizing device and the second hierarchy machine learning/recognizing device after the learning is completed.

14. The method for operating the information processing system according to claim 11, wherein a first learning period for initial neural network construction in the second hierarchy machine learning/recognizing device in order to construct a plurality of first hierarchy machine learning/recognizing devices is set,
then, a second learning period in which learning data acquired in the first learning period is loaded to the first hierarchy machine learning/recognizing device, and supervised learning is performed while actually operating the first hierarchy machine learning/recognizing device is set, and
further, after the second learning period ends, a third learning period in which machine learning recognition control using the above first hierarchy machine learning/recognizing device is performed, and cooperative learning with the second hierarchy machine learning/recognizing device is performed if necessary is set.

15. A machine learning operator, comprising:
a unit that performs an operation on data of a second layer using data of a first layer and performs an operation on data of the first layer using data of the second layer in a multi-layered neural network,
wherein weight data of deciding a relation between each piece of data of the first layer and each piece of data of the second layer in both the operations is provided, and
the weight data is stored in one storage holding unit as all weight coefficient matrices to be constructed;
an operation unit including product-sum operators which are constituent elements of the weight coefficient matrix and correspond to operations of matrix elements in a one-to-one manner,
wherein, when the matrix elements constituting the weight coefficient matrix are stored in the storage holding unit, the matrix elements are stored using a row vector of the matrix as a basic unit,
the operation of the weight coefficient matrix is performed in basic units in which the storage is performed in the storage holding unit,
a first row component of the row vector is held in the storage holding unit so that an arrangement order of constituent elements is the same as a column vector of an original matrix,
a second row component of the row vector is held in the storage holding unit after shifting the constituent element of the column vector of the original matrix to the right or the left by one element,
a third row component of the row vector is held in the storage holding unit after further shifting the constituent element of the column vector of the original matrix by one element in the same direction as a movement direction in the second row component, and
an N-th row component of the last row of the row vector is held in the storage holding unit further shifting the constituent element of the column vector of the original matrix by one element in the same direction as a movement direction in an (N−1)-th row component; and
an operator configuration in which, in a case in which the data of the first layer is calculated from the data of the second layer using the weight coefficient matrix,
the data of the second layer is arranged similarly to the column vector of the matrix, and each element is input to the product-sum operator,
at the same time, a first row of the weight coefficient matrix is input to the product-sum operator, a multiplication operation related to both pieces of data is performed, and an operation result is stored in the accumulator,
when second or less rows of the weight coefficient matrix are calculated, the data of the second layer is shifted to the left or the right each time a row operation of the weight matrix is performed, and then a multiplication operation of element data of a corresponding row of the weight coefficient matrix and the arranged data of the second layer is performed,
then, data stored in the accumulator of the same operation unit is added, and
a similar operation is performed up to an N-th row of the weight coefficient matrix, and
in a case in which the data of the second layer is calculated from the data of the first layer using the weight coefficient matrix,
the data of the first layer is arranged similarly to the column vector of the matrix, and each element is input to the product-sum operator,
at the same time, a first row of the weight coefficient matrix is input to the product-sum operator, a multiplication operation is performed, and a result is stored in the accumulator,
when second or less rows of the weight coefficient matrix are calculated, the data of the first layer is shifted to the left or the right each time a row operation of the weight matrix is performed, and then a multiplication operation of element data of a corresponding row of the weight coefficient matrix and the arranged data of the first layer is performed,
then, information of the accumulator stored in the operation unit is input to an adding unit of a neighbor operation unit, added to the result of the multiplication operation, and a result is stored in the accumulator, and
a similar operation is performed up to the N-th row of the weight matrix.
